(19) United States
(12) Patent Application Publication
(10) Pub. No.: US 2026/0087763 A1
(43) Pub. Date: Mar. 26, 2026

(54) METHOD OF TRANSFORMING 2D DISTORTED PERSPECTIVE VIEW INTO UNDISTORTED VIEW AND MOBILITY DEVICE USING THE METHOD

(71) Applicants: HYUNDAI MOTOR COMPANY, Seoul (KR); Kia Corporation, Seoul (KR)

(72) Inventors: Min Soo SONG, Hwaseong-si (KR); Hyuk Zae LEE, Hwaseong-si (KR)

(73) Assignees: HYUNDAI MOTOR COMPANY, Seoul (KR); Kia Corporation, Seoul (KR)

(21) Appl. No.: 19/064,485

(22) Filed: Feb. 26, 2025

(30) Foreign Application Priority Data
Sep. 25, 2024 (KR) 10-2024-0129810

(51) Int. Cl. G06V 10/24; G06T 3/40; G06V 10/77; G06V 10/82

(52) U.S. Cl. CPC G06V 10/243; G06T 3/40; G06V 10/7715; G06V 10/82

(57) ABSTRACT

A method for transforming a two-dimensional distorted view into an undistorted view, comprising: converting pixel indices of the distorted view into distorted normal coordinates using a lookup table defining a one-to-one mapping between distorted and undistorted coordinates; transforming the distorted normal coordinates into undistorted normal coordinates by referencing the lookup table; and generating a planar perspective view of the undistorted image by mapping depth coordinates from an undistorted coordinate system onto the undistorted normal coordinates.

### CROSS REFERENCE TO RELATED APPLICATION

The present application claims the benefit of priority to Korean provisional Patent Application No 10-2024-0129810, filed on Sep. 25, 2024, the entire contents of which are incorporated herein for all purposes by reference.

### TECHNICAL FIELD

The present disclosure relates to a method of transforming a two-dimensional distorted view into an undistorted view and a mobility device using the method, and more particularly, to a method of transforming a two-dimensional distorted view into a undistorted view using a table that models a one-to-one mapping relationship from a coordinate system in which distortion exists to a coordinate system in which distortion does not exist, and a mobility device using the method.

### BACKGROUND

Recently, the need for developing omnidirectional perception models for safe and efficient autonomous driving has been increasing. For example, Surround Depth Estimation, 3D Occupancy Prediction, and BEV Perception (bird's eye view perception) are being used as omnidirectional perception model development methodologies utilizing multiple cameras.

Among the examples described above, the BEV Perception method is efficient and has great utility because it contains sufficient information required for downstream tasks such as path planning.

However, BEV Perception assumes input of distortion-corrected multi-camera image data. BEV Perception performs view transformation from a 2D distorted perspective view into a 3D undistorted view, such as a 3D bird's eye view (BEV) space, to generate latent features containing 3D information, which can perform tasks such as object detection and semantic segmentation. Since it assumes distortion-corrected image data, it uses a pinhole camera model that assumes undistorted image data.

On the other hand, because cameras typically have distortions depending on their characteristics, the coordinates representing each pixel of the image data are expressed in a distorted coordinate system.

That is, the technology for transforming views using a pinhole camera model that assumes existing undistorted image data has the limitation of not being able to take distortion into account.

Additionally, in the coordinate system based on the pinhole camera model, since linear mapping using the intrinsic parameters of the camera is possible, that is, one-to-one coordinate transformation formula, it is possible to create a look-up table in which the coordinates of two-dimensional undistorted image data correspond one-to-one to three-dimensional undistorted world coordinates.

However, a limitation exists in that coordinate transformation on the coordinates of image data with distortion cannot be expressed as a closed-form solution because it is an ill-posed problem lacking a one-to-one correspondence.

### SUMMARY OF THE INVENTION

An object of the present disclosure is to provide a method for transforming a two-dimensional distorted view into an undistorted view using a table modeling a one-to-one mapping relationship from a coordinate system in which distortion exists to a coordinate system in which distortion does not exist, and a mobility device using the method.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

According to one or more example embodiments of the present disclosure, a method performed by an apparatus may include: transforming an image space pixel index of the distorted view as input coordinates into distorted normal coordinates using a lookup table that includes a one-to-one connection relationship between coordinates from a distorted to an undistorted direction, transforming the distorted normal coordinates into undistorted normal coordinates by referring to the lookup table and generating a bird's-eye view of the undistorted view by reflecting depth coordinates of an undistorted coordinate system to the undistorted normal coordinates.

The image space may be generated based on at least one of a feature inferred from image data using an artificial intelligence model or a depth feature.

The lookup table may be generated based on a transformation table defined based on an internal geometry in a component.

The lookup table may be generated based on an inverse function of a model defining one-to-one correspondence between the undistorted normal coordinates and the distorted normal coordinates from an undistorted to distorted direction.

The model may define a one-to-one correspondence based on a first distortion coefficient set based on distortion occurring by a distance from a component acquiring image data, an undistorted radial distance of an undistorted coordinate system and a distorted radial distance of a target distorted coordinate system.

The distorted radial distance of the model may be derived by a first logic defining a relationship depending on a radial angle of the distorted normal coordinates determining the distorted radial distance and the first distortion coefficient.

The undistorted radial distance of the inverse function may be derived based on a second logic defining a relationship where the radial angle depends on the distorted radial distance and the second distortion coefficient.

The second logic may be established based on a mapping relationship pre-formed between the distorted normal coordinates and the undistorted normal coordinates.

The second logic may be a polynomial with the second distortion coefficient acquired through polynomial curve fitting, where the distorted radial distance is a dependent variable. Generating the bird's-eye view of the undistorted view may comprise: calculating undistorted coordinates by reflecting the depth coordinates to the undistorted normal coordinates using the lookup table, transforming the undistorted coordinates via a projection matrix, and adjusting the resolution of the bird's-eye view plane to suit required voxel specifications. According to one or more example embodiments of the present disclosure, a mobility device may include: a memory configured to store at least one instruction and a processor configured to execute the at least one instruction stored in the memory based on data acquired from the memory, wherein the processor is configured to: transform an image space pixel index of the distorted view as input coordinates into distorted normal coordinates using a lookup table including a one-to-one connection relationship between coordinates from a distorted to undistorted direction transform the distorted normal coordinates into undistorted normal coordinates by referring to the lookup table generate a bird's-eye view of the undistorted view by reflecting depth coordinates of an undistorted coordinate system to the undistorted normal coordinates and performs a task using the generated bird's-eye view of the undistorted view.

### BRIEF DESCRIPTION OF THE DRAWINGS

FIG. 1 shows an example of a diagram schematically showing modules constituting a device that implements a method of transforming a distorted view into an undistorted view according to an embodiment of the present disclosure.

FIG. 2 shows an example of a flowchart showing a method of transforming a distorted view into an undistorted view according to another embodiment of the present disclosure.

FIG. 3 shows an example of a diagram showing the structure of a model in which a method of transforming a distorted view into an undistorted view according to another embodiment of the present disclosure is implemented.

FIG. 4 shows an example of a schematic diagram of a lookup table representing” a connection relationship between input coordinates and undistorted normal coordinates of the present disclosure.

FIG. 5 shows an example of a flowchart of a process for modeling a lookup table including a connection relationship for transforming coordinates of a distorted view into coordinates of an undistorted view.

FIG. 6 shows an example of a diagram illustrating a comparison between a mapping relationship based on pre-formed distorted normal coordinates and undistorted normal coordinates and a mapping relationship based on established second logic.

FIG. 7 shows an example of a diagram illustrating a mobility device communicating with another device to transmit and receive data.

FIG. 8 shows an example of a diagram schematically showing modules constituting a mobility device according to the present disclosure.

### DESCRIPTION OF THE PREFERRED EMBODIMENTS

Hereinafter, examples of the present disclosure are described in detail with reference to the accompanying drawings so that those having ordinary skill in the art may easily implement the present disclosure. However, examples of the present disclosure may be implemented in various ways and thus the present disclosure is not limited to the examples described therein.

In describing examples of the present disclosure, well-known functions or constructions have not been described in detail as a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example may be termed a first element in another example, without departing from the scope of the present disclosure.

In the present disclosure, elements are distinguished from each other for clearly describing each feature, but this does not necessarily mean that the elements are separate. In other words, a plurality of elements may be integrated in one hardware or software unit, or one element may be distributed and formed in a plurality of hardware or software units. Therefore, unless stated otherwise, such integrated or distributed examples are included in the scope of the present disclosure.

In the present disclosure, elements described in various examples do not necessarily represent essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be construed as being limited to the specific examples set forth herein. Rather, the examples described herein are provided to make this disclosure more complete and to fully convey the scope of the present disclosure to those having ordinary skill in the art to which the present disclosure pertains.

In the present disclosure, each of phrases such as “A or B”, “at least one of A and B”, “at least one of A or B”, “A, B or C”, “at least one of A, B and C”, and each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and when drawings illustrated in the present specification are inverted, the location relations described in the specification may be inversely understood. When a component, device, element, or the like of the present disclosure is described as having a purpose or performing an operation, function, or the like, the component, device, or element should be considered as being “configured to” meet that purpose or perform that operation or function.

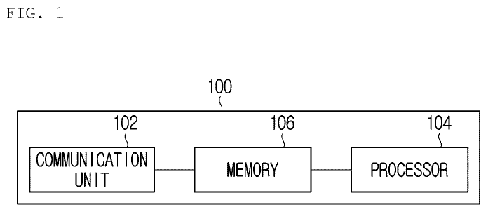

Hereinafter, with reference to FIG. 1, modules constituting a device implementing a method of transforming a distorted view into an undistorted view according to an embodiment of the present disclosure will be described. FIG. 1 is a diagram schematically illustrating modules constituting a device implementing a method of transforming a distorted view into an undistorted view, according to an embodiment of the present disclosure.

Referring to FIG. 1, the device 100 (hereinafter referred to as a server) implementing a method of transforming a distorted view into an undistorted view may include a communication unit 102, a processor 106, and a memory 104. Each component is not an essential component, and may have additional components or be omitted, and a single component may be included in or combined with another component so that the single component may perform multiple functions. For example, without conflicting with the following description, a separate module that performs a task based on image data transformed into an undistorted view may be added in addition to the processor 106. As an example, the server 100 may additionally include a task performing unit 206 to perform tasks such as object detection, semantic segmentation, and depth estimation. The tasks performed by the task performing unit 206 are not limited to the examples described above.

Additionally, the processor 106 may include a plurality of modules implementing a method of transforming a distorted view into an undistorted view according to another embodiment of the present disclosure. Hereinafter, the processor 106 may be referred to as the server 100 and used interchangeably for convenience of explanation.

Referring to FIG. 1, the server 100 may receive image data with distortion as input, transform it into an undistorted normal coordinate system, and generate a bird's-eye view of the undistorted view by reflecting depth coordinates anto the coordinates of the undistorted normal coordinate system. Specifically, the server 100 may receive coordinates of features inferred from image data of the distorted view as input coordinates, and derive undistorted coordinates by referring to a modeled lookup table. In addition, the server 100 may transform the undistorted coordinates using the lookup table, and generate a bird's-eye view of the undistorted view to suit required voxel specifications. This will be described in detail later.

In addition, the server 100 may perform appropriate tasks through the generated bird's-eye view of the undistorted view. For example, the server 100 may perform tasks such as object detection, semantic segmentation, depth estimation, and pose estimation using enhanced bird's-eye view features. The tasks that may be performed by the server 100 are not limited to the examples described above.

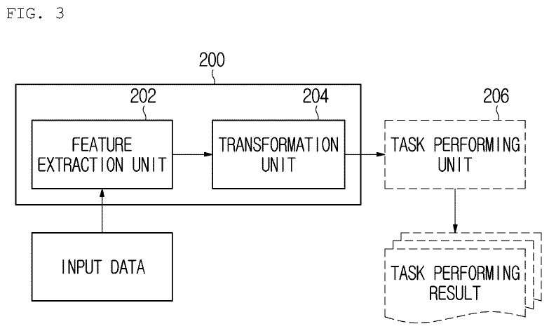

Specifically, the processor 106 of the server 100 may generate features of at least one image data by an analysis model capable of analyzing the context of the image data. The analysis model may employ an image analysis artificial intelligence model capable of simultaneously processing a plurality of image data and generating a plurality of features. As an example, the image analysis artificial intelligence model may include YOLO (You Only Look Once) employing a CNN (Convolutional Neural Network) structure, R-CNN (Regions with Convolutional Neural Network), or an artificial intelligence model employing a transformer structure, but is not limited to the examples described above. As an example, the server 100 may construct an image space based on at least one feature inferred using the analysis model or a depth feature, and may use a pixel index of the image space as an input coordinate. Detailed processing will be described with reference to FIG. 3.

The model referred to in the present disclosure may also be referred to as a network, a neural network, a learning model, an artificial neural network, an artificial intelligence model, and a deep learning model. In addition, the artificial intelligence model used in the present disclosure may be pre-trained.

The server 100 distributes a distortion correction module 200 that performs actual processing of transforming a two-dimensional distorted view into an undistorted view to generate a bird's-eye view to a mobility device (see 300 of FIG. 10), so that the mobility device 300 may utilize the distributed distortion correction module 200 for driving control. The distortion correction module 200 may include functional configurations such as a feature extraction unit 202 and a transformation unit 204, and may also include the task performing unit 206 that performs a task using the generated bird's-eye view. This will be described in detail later.

The mobility device 300 refers to a device that may move to a specific point. The mobility device 300 may be any one of devices such as a ground vehicle that drives on the ground, a mobile robot that is autonomously or remotely controlled, a work robot for a specific purpose, etc. In addition, the mobility device 300 is not limited to a ground mobility device, and may be, for example, an air mobility device, a water mobility device for water transportation, or an underwater mobility device (e.g., a submarine). The mobility device 300 may operate autonomously or manually. The mobility device 300 when operated autonomously may be implemented as semi-autonomous driving or fully autonomous driving. Fully autonomous driving refers to autonomous driving in which a controller of the mobility device 300 completely performs control without user intervention even when a driving situation is uncertain. Semi-autonomous driving may be provided as autonomous driving that requires driver intervention depending on a specific driving situation. Semi-autonomous driving may be implemented by allowing the user to drive manually by having the controller of the mobility device 300 deactivate autonomous driving when the above situation occurs and transfer control to the user. According to the levels of autonomous driving defined by the Society of Automotive Engineers (SAE), semi-autonomous driving corresponds to autonomous driving levels 1 to 4, and fully autonomous driving corresponds to level 5.

The server 100 may, for example, be a device, such as a server, provided separately from the mobility device 300 to be operated by a vehicle manufacturer or a management agency providing autonomous driving services. If the server 100 is a server operated by a vehicle manufacturer or management agency supporting autonomous driving, it may receive connected data of the mobility device 300 or transmit data required for autonomous driving. In order to support autonomous driving and various services of the mobility device 300, the server 100 may transmit various information and software modules used for controlling the mobility device 300 to the mobility device 300 in response to requests and data transmitted from the mobility device 300 and a user device. In the present disclosure, the processing of the server 100 related to a method of transforming a two-dimensional distorted view into an undistorted view according to another embodiment will be mainly described.

The communication unit 102 of the server 100 may support mutual communication with the mobility devices 300 and 400, an 5 ITS device 300, etc. In the present disclosure, the communication unit 102 may be a communication interface that receives various data and networks (or algorithms) used to generate the distortion correction module 200 that supports driving and convenience functions of the mobility device 300, and transmits information and networks related to the distortion correction module 200 to the mobility device 300. In addition, the communication unit 102 may be a communication module that receives data generated or stored during driving from the mobility device 300, and transmits information supporting driving, such as map information, environmental information recognizing objects around the mobility device 300, traffic information, weather information, etc. to the mobility device 300. The communication unit 102 may also serve as a communication module that transmits applications related to driving and convenience functions.

The memory 104 stores a program and various data for controlling the server 100, and may load a program or read and record data at the request of the processor 106. The memory 104 may manage image data utilized in the distortion correction module 200 or video data, which is sequential image data. The video data may include multi-view image data including distortion acquired by cameras 204b mounted at multiple locations of the mobility device 300 centered on the mobility device 300. Additionally, it goes without saying that the video data may be composed of a combination of sequential image data of distorted views. Additionally, the memory 104 may manage a mapping relationship pre-formed between the coordinates of the data of the distorted view and the coordinates of the data of the undistorted view where the distortion is corrected.

The distortion correction module 200 may be configured to include the functional modules 202 and 204 illustrated in FIG. 3, which will be described later. The distortion correction module 200 may also include the task performing unit 206 that performs the task using the generated bird's-eye view.

The video data may include images collected from multiple mobility devices 300 and 400 and/or a database (DB) for typical learning data, depth maps, depth information provided in a point cloud format, etc. In addition to the data described above, the memory 104 may also store applications for implementing driving and convenience functions of the mobility device 300, map information, traffic information, weather information, and other various information affecting driving.

The processor 106 may perform overall control of the server 100 and execute applications and instructions stored in the memory 104. Specifically, it may control the server 100 to process the distortion correction module 200 using the video data and distribute the module to the mobility device 300. Additionally, the processor 106 may generate a lookup table with a one-to-one correspondence between coordinates from a distorted to undistorted direction, used in the distortion correction module 200. For example, the processor 106 may set a transformation table for transforming a pixel index of an image space generated based on at least one of a feature inferred from an analysis model or a depth feature into distorted normal coordinates in order to generate a lookup table. The transformation table may be defined differently according to geometric information of the cameras mounted on the mobility device 300 to be distributed. At this time, the geometric information may include intrinsic parameters and extrinsic parameters of the cameras.

The processor 106 may infer an inverse function of a model defining a one-to-one correspondence from an undistorted to distorted direction, in order to generate a lookup table containing a one-to-one connection relationship between coordinates from a distorted to undistorted direction.

Additionally, the processor may determine an image analysis model to be employed as an analysis model, and may use a pre-trained image analysis model as the image analysis model, or determine learnable parameters of the image analysis model through training.

Additionally, information according to the operation of the distortion correction module 200 distributed to the mobility devices 300 and 400 and the same data as the video data from the mobility devices 300 and 400, and update the distortion correction module 200 based on the received information and data. The processor 106 may distribute the updated distortion correction module 200 to the mobility devices 300 and 400.

In addition, the processor 106 may perform processing to receive an image space pixel index of a distorted view as an input coordinate through the distortion correction model 200, transform it into distorted normal coordinates using a lookup table including a one-to-one connection relationship between coordinates from a distorted to undistorted direction, transform the distorted normal coordinates into undistorted normal coordinates by referring to the lookup table, and generate a bird's-eye view of the undistorted view by reflecting depth coordinates inferred from a depth feature to the undistorted normal coordinates.

In addition, the processor 106 may perform task processing using the generated bird's-eye view of the undistorted view.

In addition, the processor 106 may perform processing to support driving and convenience functions of the mobility device 300. In the present disclosure, the processor 106 may be implemented as a single processing module. Alternatively, the processing described above may be distributed across multiple processing modules, and the processor 106 may collectively refer to these modules in the present disclosure.

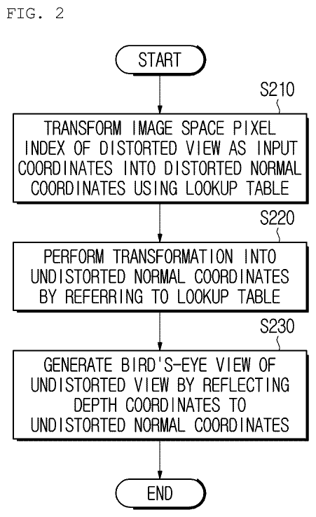

Hereinafter, a method of transforming a distorted view into an undistorted view using a lookup table according to another embodiment of the present disclosure will be described in detail with reference to FIGS. 2 and 3.

FIG. 2 is a flowchart showing a method of transforming a distorted view into an undistorted view according to another embodiment of the present disclosure, and FIG. 3 is a diagram showing the structure of a model in which a method of transforming a distorted view into a undistorted view according to another embodiment of the present disclosure is actually implemented.

A model in which a method of transforming a distorted view into an undistorted view is practically implemented in FIG. 3 may be a software module processed by the processor 106, and the processor 106 may process requests from the modules listed in FIG. 3.

In the present disclosure, the processing of the distortion correction module 200 according to the embodiment is mainly described as being performed only in the server 100. However, the distortion correction module 200 described below may be distributed and processed in the server 100 and other devices, as long as it does not conflict with the description below. The other devices may be, for example, other servers and/or the mobility devices 300 and 400. Hereinafter, the processor 106 of the server 100 may be referred to simply as the server 100 for convenience of description, and these terms may be used interchangeably.

Referring to FIG. 2, the processor 106 of the server 100 processes a request from the transformation unit 204 to transform the image space pixel index of the distorted view as input coordinates into distorted normal coordinates using a lookup table (S210).

The processor 106 of the server 100 generates features through an analysis model used as a feature extraction unit 202 to generate the image space of the distorted view. Input data input to the analysis model may be static images acquired in time series or continuously from the cameras mounted on the mobility device 300 or another device and/or video data representing a series of movements in an object as continuous frames. Additionally, the video data may be an image acquired from changing surrounding environment of a driving ego-vehicle by a mono camera mounted on the ego-vehicle, or an image acquired from a changing surrounding environment by each of multi-camera mounted on the ego-vehicle.

When a convolutional neural network (CNN) structure is used as an image analysis model, the features may mean a feature map that analyzes the features of the input image data. As another example, when a transformer structure is used as an image analysis model, the features may mean information on each patch of image data divided into predetermined patches, a relationship between patches, a global image context including the context of the image, etc. The structure that may be employed as an image analysis model is not limited thereto, and may include all artificial neural network structures that may be used as a premise for performing tasks such as object detection, semantic segmentation, depth estimation, and pose estimation within a scope that does not conflict with the present disclosure.

In addition, the processor 106 of the server 100 may generate depth features using the image analysis model described above.

The processor 106 transforms, as input coordinates, a pixel index in the image space of the distorted view into distorted normal coordinates by using a lookup table including a one-to-one connection relationship between coordinates from a distorted to an undistorted direction. For example, the lookup table may include a connection relationship between coordinates to which coordinates are transformed by a transformation table defined in geometric information of the camera 204b. For example, the transformation table may be defined based on the internal geometry of the camera 204b. Specifically, the processor 106 transforms the input coordinates into distorted normal coordinates by referring to the one-to-one connection relationship between coordinates defined in the lookup table. For example, the distorted normal coordinates may be represented as a three-dimensional vector.

Next, the processor 106 performs transformation into undistorted normal coordinates by referring to the lookup table (S220). For example, the lookup table may include a connection relationship between coordinates that is transformed based on an inverse function of a model that defines a one-to-one correspondence from undistorted to distorted direction between undistorted normal coordinates and distorted normal coordinates. For example, the model may define a correspondence between undistorted normal coordinates and distorted normal coordinates based on a distortion coefficient and a radial distance that are based on distortion occurring at a distance from a component that acquires video data, for example, the camera 204b. The inverse function may define a one-to-one correspondence from distorted to undistorted direction based on the model. That is, the processor 106 transforms the distorted normal coordinates into undistorted normal coordinates using a lookup table containing a connection relationship between undistorted and distorted normal coordinates, established by the inverse function.

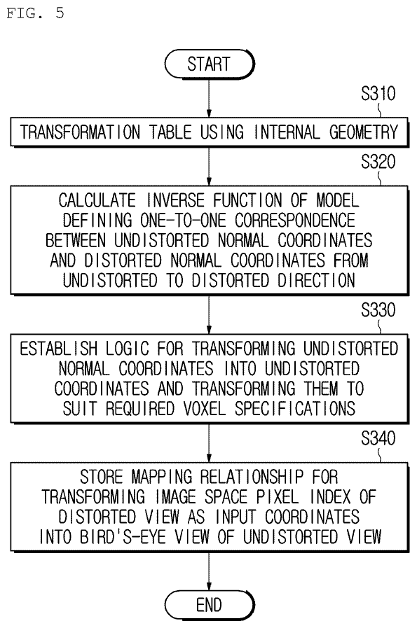

Next, the processor 106 generates a bird's-eye view of the undistorted view by mapping the depth coordinates onto the undistorted normal coordinates (S230). For example, the processor 106 may generate the bird's-eye view by referring to a lookup table. The lookup table may include a connection relationship between the undistorted normal coordinates and the undistorted coordinates according to a logic for calculating the undistorted coordinates by reflecting the depth coordinates to the undistorted normal coordinates. In addition, the lookup table may include a connection relationship including a logic for changing the bird's-eye view resolution to suit the requested voxel specifications while transforming the undistorted coordinates through a projection matrix. That is, the lookup table may include a connection relationship referred to in the processing of S210 to S230, and the process of generating the lookup table and detailed processing for each process will be described later with reference to FIG. 5.

Additionally, the processor 106 may process a request of the task performing unit 206 using the generated bird's-eye view. For example, the processor 106 may perform tasks such as semantic segmentation and object detection using the generated bird's-eye view.

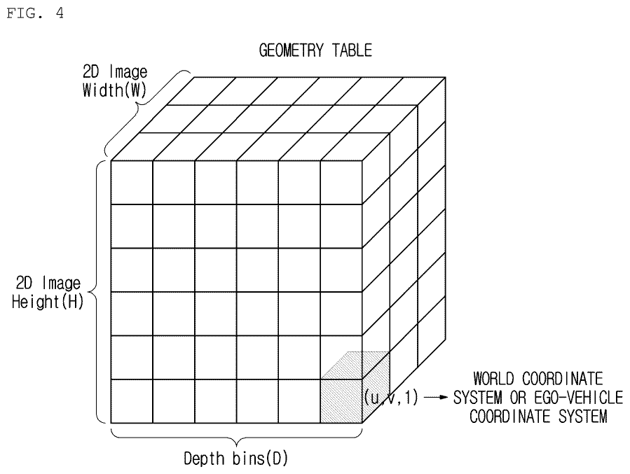

Hereinafter, the processor 106 will be described with reference to FIGS. 4 and 5 for the lookup table used to perform processing of S210 to S230. FIG. 4 is a schematic diagram of a lookup table expressing a connection relationship between input coordinates and undistorted normal coordinates. FIG. 5 is a flowchart of a process for modeling a lookup table including a connection relationship for transforming coordinates of a distorted view into coordinates of an undistorted view.

The data structure illustrated in FIG. 4 may be a geometry table expressing the relationship between the input coordinates of the image plane and the index information of the bird's-eye view matching it. The processor 106 may use the geometry table as a lookup table.

Referring to FIG. 4, each cell of the table may include index information matching an ego-vehicle plane index matching a pixel index of an image plane. That is, the lookup table may include a one-to-one correspondence set of pixels so that an image plane pixel index obtained from two-dimensional video data may be unprojected to a corresponding location on a three-dimensional world plane (or world coordinate system) or ego-vehicle plane (or ego-vehicle coordinate system).

The process of modeling the logic for generating a lookup table will be described below through FIG. 5. The processor 106 defines a transformation table using internal geometry (S310).

The transformation table may be formed based on a component that acquired video data, such as a focal length, principal point, etc. of the camera 204b, and may include non-orthogonality correction parameters for correcting asymmetric pixels.

The processor 106 may generate distorted normal coordinates (x_{d}, y_{d}) using a transformation table with the pixel index of the image plane of the input video data as the input coordinates (u, v). The distorted normal coordinates (x_{d}, y_{d}) may mean coordinates corresponding to the x-axis and y-axis on the normal coordinate system of the camera 204b including the distortion.

Next, the processor 106 calculates the inverse function of the model that defines a one-to-one correspondence between undistorted normal coordinates and distorted normal coordinates from an undistorted-to-undistorted direction (S320).

The model may include a definition of a one-to-one correspondence based on a distortion coefficient (hereinafter, the first distortion coefficient kₙ) set based on a distortion caused by a distance from a component that acquired video data, an undistorted radial distance rₙ in an undistorted coordinate system, and a distorted radial distance r_{d} in a target distorted coordinate system. Specifically, the model may define a correspondence from undistorted normal coordinates (xₙ, yₙ) to distorted normal coordinates (x_{d}, y_{d}) based on the above-described first distortion coefficient kₙ, the undistorted radial distance rₙ, and the distorted radial distance r_{d}.

More specifically, the distorted radial distance r_{d} in the model may be derived by a first logic that defines a relationship dependent on the radial angle θ of the distorted normal coordinates (x_{d}, y_{d}) that determines the distorted radial distance r_{d} and the first distortion coefficient kₙ. As an example, the first logic may include a polynomial relationship between the radial angle θ, the first distortion coefficient kₙ, and the distorted radial distance r_{d}. As an example, the model may define a correspondence from the undistorted normal coordinates (x_{d}, y_{d}) to the distorted normal coordinates (xₙ, yₙ) via [Equation 1] below.

$$( \begin{matrix}{x}_{d} \\ {y}_{d}\end{matrix} ) = ( \begin{matrix}{r}_{d} ( θ ) cos Φ \\ {r}_{d} ( θ ) sin Φ\end{matrix} ) = ( \begin{matrix}{r}_{d} ( θ ) \frac{{x}_{n}}{{r}_{n}} \\ {r}_{d} ( θ ) \frac{{y}_{n}}{{r}_{n}}\end{matrix} ) = \frac{{r}_{d} ( θ )}{{r}_{n}} ( \begin{matrix}{x}_{n} \\ {y}_{n}\end{matrix} ) = \frac{θ}{{r}_{n}} [ 1 + {k}_{1} {θ}^{2} + {k}_{2} {θ}^{4} + {k}_{3} {θ}^{6} + {k}_{4} {θ}^{8} ] ( \begin{matrix}{x}_{n} \\ {y}_{n}\end{matrix} ) , \qquad [ Equation 1 ]$$

where θ=tan⁻¹(rₙ)

Next, the processor 106 defines the inverse function of the model. However, for a simple inverse relationship, e.g.,

$$( \begin{matrix}{x}_{n} \\ {y}_{n}\end{matrix} ) = \frac{{r}_{n}}{{r}_{d}} ( \begin{matrix}{x}_{d} \\ {y}_{d}\end{matrix} ) ,$$

the undistorted normal coordinates (xₙ, yₙ) for obtaining the undistorted radial distance rₙ may be obtained as the result of the inverse function, so the processor 106 derives the undistorted radial distance rₙ using the radial angle θ.

Specifically, the processor 106 establishes a second logic that defines a relationship in which the radial angle θ depends on the distorted radial distance r_{d} and the undistorted coefficient (hereinafter, referred to as the second distortion coefficient). For example, the processor 106 estimates a combination of the distorted radial distance r_{d} and the second distortion coefficient that becomes equal to the radial angle θ by using the tangent relationship between the radial angle θ and the undistorted radial distance rₙ (θ=tan⁻¹(rₙ)). That is, the processor 106 may estimate the radial angle θ from the obtained distorted radial distance r_{d} and derive the undistorted radial distance rₙ based on the radial angle θ. For example, the processor 106 may calculate the undistorted radial distance rₙ by using [Equation 2] below as the second logic.

$$θ ( {r}_{d} ) = {l}_{0} {r}_{d} + {l}_{1} {r}_{d}^{3} + {l}_{2} {r}_{d}^{5} + {l}_{3} {r}_{d}^{7} + {l}_{4} {r}_{d}^{9} \qquad [ Equation 2 ]$$

The processor 106 may use the mapping relationship between the pre-formed distorted normal coordinates and undistorted normal coordinates to infer the second distortion coefficient lₙ for deriving the radial angle θ according to the distorted radial distance r_{d}. Specifically, the processor 106 may infer the second distortion coefficient lₙ by using the relationship between the collected radial angle θ and the distorted radial distance r_{d} based on the pre-formed distorted normal coordinates and undistorted normal coordinates.

For example, the processor 106 may infer the second distortion coefficient lₙ based on a polynomial curve fitting with the distorted radial distance r_{d} as a dependent variable. Also, for example, the processor 106 may infer the second distortion coefficient lₙ based on a polynomial curve fitting using a Newton-Raphson based method.

The processor 106 infers the second distortion coefficient lₙ until a difference between the collected radial angle θ corresponding to the collected distorted radial distance r_{d} and the radial angle θ derived by the above-described processing converges below a predetermined threshold.

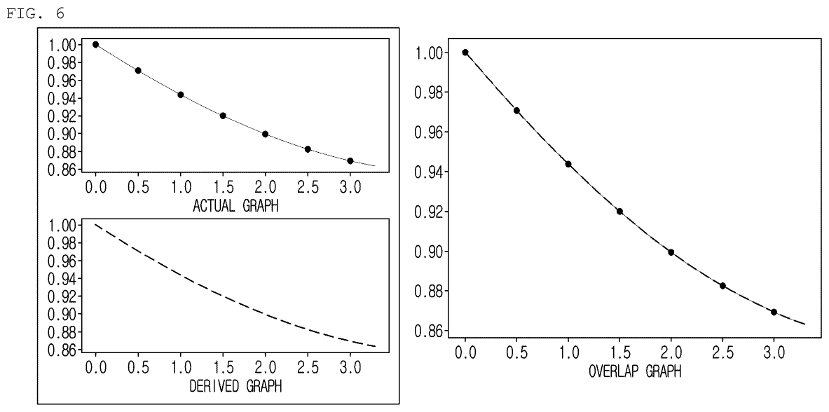

The difference between the radial angle θ corresponding to the distorted radial distance r_{d} derived by the above-described processing and the collected radial angle θ corresponding to the collected distorted radial distance r_{d} will be explained through FIG. 6.

FIG. 6 is a diagram illustrating a comparison between a mapping relationship based on pre-formed distorted normal coordinates and undistorted normal coordinates and a mapping relationship by the established second logic.

Looking at the overlap graph illustrated in FIG. 6, it can be confirmed that the graph of the collected radial angle θ corresponding to the distorted radial distance r_{d} collected from the actual data and the polynomial graph of the collected radial angle θ corresponding to the derived distorted radial distance r_{d} are fitted.

Next, the processor 106 establishes a logic for transforming the undistorted normal coordinates obtained in step S320 into undistorted coordinates and transforming them to suit the voxel specifications required when generating a bird's-eye view (S330).

The processor 106 may reflect the depth coordinates of the undistorted coordinate system acquired from the depth feature inferred using the analysis model to the undistorted normal coordinates. Additionally, if the processor 106 acquires depth coordinates from a lidar sensor, it may map the depth coordinates onto the undistorted normal coordinates. For example, the processor 106 may multiply the depth coordinates by the undistorted normal coordinates element by element to generate three-dimensional undistorted coordinates. For example, the processor 106 may multiply the depth coordinates by the undistorted normal coordinates element by element and utilize the depth coordinates as depth information of the undistorted coordinates.

Next, the processor 106 may transform the undistorted coordinates using a projection matrix. Specifically, the processor 106 may transform the undistorted coordinates by defining a projection matrix that performs rotation transformation and translation transformation into the ego-vehicle coordinate system. As an example, the processor 106 transforms the undistorted coordinates using a projection matrix that includes a rotation matrix that rotates the undistorted coordinates and a transformation vector that translates the undistorted coordinates.

Additionally, the processor 106 establishes a logic to transform the transformed undistorted coordinates to suit the voxel specifications required for generating the bird's-eye view. For example, the processor 106 establishes a logic to transform the transformed undistorted coordinates into voxel indices based on a voxel minimum range (voxel_min_range) or a voxel size (voxel_size) required according to system settings or user input.

The processor 106 sets the resolution of the bird's-eye view plane by defining the required voxel range and the voxel size and maps the undistorted coordinates to the bird's-eye view plane based on these parameters.

The processor 106 establishes a logic for processing steps S310 to S330, and based on this, stores a mapping relationship for transforming an image space pixel index of a distorted view as input coordinates into a bird's-eye view of an undistorted view (S340). That is, the processor 106 may construct a one-stage mapping relationship that may transform video data containing distortion into undistorted coordinates and also perform view transformation until an undistorted bird's-eye view is generated. In the case of offline fixing of camera geometry information, that is, the geometry information of the camera 204b mounted on the mobility device 300 may be established in advance, and an index space including a coordinate transformation connection relationship may be stored in the form of a lookup table based on this. Accordingly, the mobility device 300 may transform video data into undistorted coordinates from which distortion has been removed using only low-computational resources by using the distributed lookup table. In addition, the above-described lookup table generation logic may be placed as a plug-in-play in front of the input unit of the analysis model to perform transformation into undistorted coordinates from which distortion has been removed using only low-computational resources. Through this, computational resources can be effectively reduced by performing end-to-end extraction of undistorted three-dimensional features from video data containing distortion.

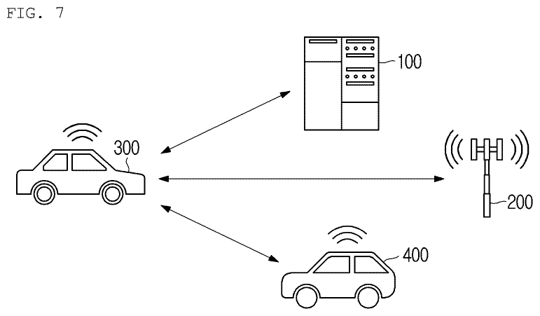

FIG. 7 is a diagram a mobility device communicating with another device to transmit and receive data.

The mobility device 300 may refer to a device that may move to a specific point, as described above in FIG. 1. In the present disclosure, the mobility device 300 is described as a vehicle that runs on the ground, but the present disclosure may also be applied to a mobility device for flying or water transportation. The mobility device 300 may be controlled and driven autonomously, as described above in FIG. 1, and the autonomous driving may be implemented as semi-autonomous driving or fully autonomous driving.

The mobility device 300 may be driven by electric energy or fossil energy. In the case of electric energy, the mobility device 300 may employ, for example, a pure battery-based vehicle driven only by a high-voltage battery or a gas-based fuel cell as an energy source. In addition, the fuel cell may utilize various forms of gas capable of generating electric energy, and the gas may be, for example, hydrogen. However, the disclosure is not limited thereto, and various gases may be applied. In the case of fossil energy, the mobility device 300 is driven by fuel such as gasoline, diesel, or liquefied gas, and may be equipped with an engine that drives a wheel drive unit 214 by combustion of the fuel. The engine may be part of a power source unit 212, providing the driving rotational force to the wheel drive unit 214. As another example, the mobility device 300 may also be driven by a hybrid method of electric energy and fossil energy.

Meanwhile, the mobility device 300 may communicate with other devices 100 and 200 or another mobility device 400. The other devices may include, for example, the server 100 that supports various controls, status management, and driving of the mobility device 300, an ITS device 200 for receiving information from an ITS (Intelligent Transportation System), various types of user devices, etc. The server 100 may be, for example, an external device operated by a vehicle manufacturer or a management organization that provides autonomous driving services, as described above in FIG. 1.

The ITS device 200 is, for example, a road side unit (RSU), and the ITS device 200 may exchange vehicle recognition data, driving control and status data, environmental data around the vehicle, map data, etc. with the mobility device 300 via V2I to assist the user's ego-vehicle driving or support autonomous driving of the mobility device 300. The mobility device 300 may exchange the data listed above with another mobility device 400 via V2V to support ego-vehicle driving or autonomous driving.

The mobility device 300 may communicate with other vehicles or other devices based on cellular communication, WAVE (Wireless Access in Vehicular Environment) communication, DSRC (Dedicated Short Range Communication) or short-range communication, or other communication methods.

For example, the mobility device 300 may use a cellular communication network such as LTE or 5G, a Wi-Fi communication network, or a WAVE communication network for communication with the server 100, the ITS device 200, and another mobility device 400. As another example, DSRC or the like used in the mobility device 300 may be used for communication between vehicles. The communication method among the mobility device 300, the server 100, the ITS device 200, another mobility device 400, and the user device is not limited to the above-described embodiment.

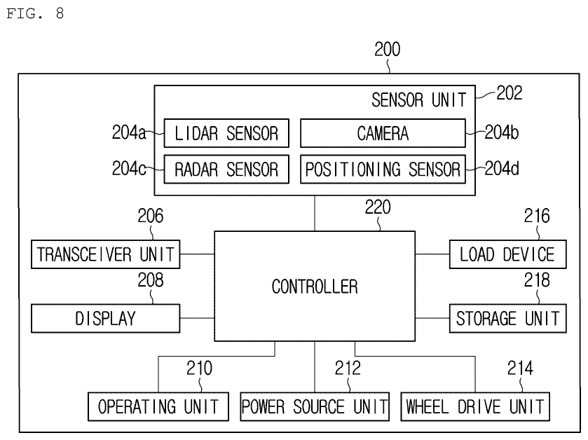

FIG. 8 is a diagram schematically showing modules constituting a mobility device according to the present disclosure. The mobility device 300 of FIG. 8 exemplifies a ground vehicle.

The mobility device 300 may include a sensor unit 202, a transceiver unit 206, and a display 208.

The sensor unit 202 may include various types of detectors that monitor states and situations in the external and internal environments of the mobility device 300 and determine its location information. That is, the sensor unit 202 is configured as a multi-sensor module including heterogeneous sensors and may acquire sensing data detected from each sensor.

Specifically, the sensor unit 202 may have a lidar sensor 204a, a camera 204b functioning as an image sensor, a radar sensor 204c to recognize dynamic and static objects existing around the mobility device 300, and a positioning sensor 104d to acquire location information of the vehicle. The sensor unit 202 may acquire sensor data including 3D recognition data, perception observation data, and location data by the above-described sensors.

The lidar sensor 204a may be a sensor that observes the surrounding environment based on laser scanning and perceives the three-dimensional shape of an object.

The camera 204b may acquire two-dimensional image data or images (or image data) having depth information of the surrounding environment or objects of the mobility device 300 in a time-series manner. The camera 204b may be installed in multiple parts of the mobility device 300, so that multiple images or multi-views of the surrounding environment of the mobility device 300 may be acquired. That is, the camera 204b may acquire information about the surrounding environment not only in a time-series manner but also continuously from the perspective of the mobility device 300.

The radar sensor 204c may, for example, irradiate radio waves with a predetermined wavelength to the surroundings and detect the behavior of the object based on the radio waves reflected from the object. The behavior of the object may include, for example, the presence or absence of the object, movement of the object, the distance between the mobility device 300 and the object, the speed of the object, the direction of movement, etc.

The sensor unit 202 may be equipped with, in addition to the positioning sensor 104d, a gyro sensor, an acceleration sensor, a wheel sensor, an odometer, a speed sensor, etc., to check its own position, driving attitude, and speed. In addition, the sensor unit 202 may have an inner-directed image sensor, a biometric sensor that detects biometric signals of the driver and passengers, and various detection modules that detect the operations and statuses of the internal devices, to monitor the statuses of users and passengers inside the mobility device 300 and the operation statuses of internal vehicle devices that may be operated by the user.

In the present disclosure, the sensors of the sensor unit 202 referred to in the description of the embodiment are mainly described, but sensors that detect various situations not listed therein may be additionally included.

The transceiver unit 206 may support mutual communication with the server 100 and the mobility device 300 around the ITS device 200. In this disclosure, the transceiver unit 206 may transmit data generated or stored during driving to the server 100 and receive data and software modules from the server 100. In the present disclosure, the mobility device 300 may transmit and receive data utilized in the method according to the present disclosure to and from the outside via the transceiver unit 206.

The display 208 may function as a user interface. The display 208 may display, by a controller 106, the operating status of the mobility device 300, the control status, the route/traffic information, the remaining energy information, the content requested by the driver, etc. The display 208 is configured as a touchscreen capable of detecting the driver's input, and may receive the driver's request for the processor 106.

Additionally, the mobility device 300 may include an operating unit 210, a power source unit 212, a wheel drive unit 214, and a load device 216.

The operating unit 210 has at least one module that implements a driving motion, and may perform at least one driving motion among longitudinal control such as acceleration/deceleration and lateral control such as steering. The operating unit 210 may include various modules to enable the wheel drive unit 214 to generate driving motions according to user requests, such as a pedal and a steering wheel, which receive user input for control.

The power source unit 212 may generate and supply power and electric power used for a driving power system such as the wheel drive unit 214 and the load device 216. If the mobility device 300 is driven based on electric energy, the power source unit 212 may be composed of, for example, an electric battery, or a combination of an electric battery and a fuel cell that charges the battery. For a combination of an electric battery and a fuel cell, the power source unit 212 may include a tank that stores a material used to generate electric power for the fuel cell, for example, hydrogen gas. If the mobility device 300 is driven based on fossil energy, the power source unit 212 may be composed of an internal combustion engine.

The wheel drive unit 214 may include multiple wheels, a driving force transmission module to generate and transmit driving force to the wheels, a braking module to decelerate the wheels, and a steering module for lateral control of the wheels. If the mobility device 300 is driven based on electric energy, the driving force transmission module may be composed of a motor module for generating driving force based on power output from an electric battery. If the mobility device 300 is operated based on fossil energy, the driving force transmission module may have a transmission or gear module for transmitting power of an internal combustion engine.

In the present disclosure, the operating unit 210 and the wheel drive unit 214 may constitute an actuating unit that transmits power generated by the power source unit 212 to externally implement driving motions and postures, etc. In the present disclosure, the actuating unit is referred to as an actuator, and these terms may be used interchangeably.

The load device 216 is mounted on the mobility device 300 and may be an auxiliary device that consumes power supplied from the power source unit 212 or power transformed from the output of the power source unit 212 by use by a passenger or a user. The load device 216 may be a type of non-driving electric device excluding a driving power system such as the wheel drive unit 214 in the present disclosure. The load device 216 may include, for example, an air conditioning system, a lighting system, a seat system, and various devices installed on the mobility device 300.

In addition, the mobility device 300 may include a storage unit 218 and a controller 220.

The storage unit 218 stores applications and various data for controlling the mobility device 300, and may load applications or read and record data at the request of the controller 220. In the present disclosure, the storage unit 218 may receive and manage a bird's-eye view transformation module, etc. from the server 100. In addition, the storage unit 218 may receive and manage information necessary for driving, such as map information, traffic information, weather information, and accident information.

The controller 220 may perform overall control of the mobility device 300. The controller 220 may oversee the overall control of the mobility device 300. It may execute applications and instructions stored in the storage unit 218. Specifically, the controller 220 may store the distortion correction module 200 or the lookup table generated according to the present disclosure in the storage unit 218 to transform a distorted view of the information into a undistorted view using information from the sensor unit 202 and generate a undistorted bird's-eye view to perform tasks such as semantic segmentation and object detection based on the information. The controller 220 may utilize the output result of the bird's-eye view transformation module together with various data recognized from the lidar sensor 204a, the camera 204b, the radar sensor 204c, and the positioning sensor 204d for autonomous driving control. Specifically, the controller 220 may use the stored distortion correction module 200 or the undistorted bird's-eye view produced by the lookup table generated according to the present disclosure as input data for an artificial intelligence model used for autonomous driving control.

In the present disclosure, the controller 220 may be implemented as a single processing module, for example. As another example, the processing according to the above-described matters may be distributed and processed in a plurality of processing modules, and the controller 220 may be referred to collectively as a plurality of processing modules in the present disclosure.

According to the present disclosure, it is possible to provide a method of transforming a two-dimensional distorted view into an undistorted view using a table modeling a one-to-one mapping relationship from a coordinate system in which distortion exists to a coordinate system in which distortion does not exist, and a mobility device using the method.

In addition, a lookup table including a one-to-one connection relationship for transforming video data including distortion into an undistorted coordinate system can be modeled.

In addition, it is possible to provide a technique for estimating undistorted coefficients required to establish a one-to-one correspondence from a distorted to an undistorted direction.

In addition, it is possible to provide a solution in the form of a formula that may perform a one-to-one coordinate transformation from a distorted to undistorted direction.

In addition, it has an end-to-end structure from image data containing distortion to undistorted feature extraction of undistorted 3D, and a method of performing view transformation in one stage is provided, thereby effectively reducing computational resources.

In addition, when fixing the parameters of the camera offline during task execution, an index space containing the coordinate transformation relationship can be stored in the form of a lookup table, thereby increasing computational efficiency.

In addition, since it is applied to cameras that include various types of distortion, it can be applied regardless of the type of camera distortion model.

In addition, it can prevent most of the ROI (region of interest) from being lost when correcting the distortion of image data.

It will be appreciated by persons skilled in the art that the effects achieved through this disclosure are not limited to what has been described herein and that other advantages will become clearer from the detailed description. While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. When implementing this disclosure in hardware, it can be achieved using application-specific integrated circuits (ASICs), digital signal processors (DSPs), digital signal processing devices (DSPDs), programmable logic devices (PLDs), field-programmable gate arrays (FPGAS), general processors, controllers, microcontrollers, microprocessors, and similar devices.

The scope of this disclosure includes software or machine-executable commands (e.g., an operating system, application, firmware, or program) to enable operations according to the methods described, as well as a non-transitory computer-readable medium storing such software or commands for execution on an apparatus or computer.

What is claimed is:

1. A method of transforming a two-dimensional distorted view into an undistorted view, the method comprising using a processor configured to:
transform an image space pixel index of the distorted view as input coordinates into distorted normal coordinates using a lookup table including a one-to-one connection relationship between coordinates from a distorted to an undistorted direction;
transform the distorted normal coordinates into undistorted normal coordinates using the lookup table; and
generate a bird's-eye view of the undistorted view by mapping depth coordinates of an undistorted coordinate system onto the undistorted normal coordinates.

2. The method of claim 1, wherein the image space is generated by the processor, based on at least one feature inferred from image data using an artificial intelligence model or a depth feature.

3. The method of claim 1, wherein the lookup table is generated by the processor using a transformation table defined based on an internal geometry of a component.

4. The method of claim 1, wherein the lookup table is derived by the processor, from an inverse function of a model that defines a one-to-one correspondence between the undistorted normal coordinates and the distorted normal coordinates from an undistorted to distorted direction.

5. The method of claim 4, wherein the model defines the one-to-one correspondence using a first distortion coefficient set determined by distortion caused by a distance from a component acquiring image data, an undistorted radial distance of the undistorted coordinate system and a distorted radial distance of a target distorted coordinate system, using the processor.

6. The method of claim 5, wherein the distorted radial distance of the model is derived by the processor using a first logic that defines a relationship based on a radial angle of the distorted normal coordinates and the first distortion coefficient.

7. The method of claim 6, wherein the undistorted radial distance of the inverse function is derived by the processor using a second logic that defines a relationship where the radial angle is dependent on the distorted radial distance and a second distortion coefficient.

8. The method of claim 7, wherein the second logic is derived by the processor from a predefined mapping relationship between the distorted normal coordinates and the undistorted normal coordinates.

9. The method of claim 7, wherein the second logic is a polynomial, wherein the second distortion coefficient is determined by the processor using a polynomial curve fitting with the distorted radial distance as a dependent variable and the distorted radial distance as another dependent variable.

10. The method of claim 1, wherein the generating the bird's-eye view of the undistorted view comprising using the processor to:
calculate undistorted coordinates by mapping the depth coordinates onto the undistorted normal coordinates using the lookup table; and
transform the undistorted coordinates using a projection matrix and adjust a resolution of the bird's-eye view plane projected to meet required voxel specifications.

11. A mobility device for transforming a two-dimensional distorted view into an undistorted view, the mobility device comprising:
a memory configured to store at least one instruction; and
a processor configured to execute the at least one instruction stored in the memory based on data acquired from the memory,
wherein the processor is configured to:
transform an image space pixel index of the distorted view as input coordinates into distorted normal coordinates using a lookup table that defines a one-to-one connection relationship between coordinates from a distorted to an undistorted direction;
transform the distorted normal coordinates into undistorted normal coordinates using the lookup table;
generate a bird's-eye view of the undistorted view by mapping depth coordinates of an undistorted coordinate system onto the undistorted normal coordinates; and
perform a task using the generated bird's-eye view of the undistorted view.

12. The mobility device of claim 11, wherein the image space is generated by the processor, based on at least one feature inferred from image data using an artificial intelligence model or a depth feature.

13. The mobility device of claim 11, wherein the lookup table is generated by the processor using a transformation table defined based on an internal geometry of a component.

14. The mobility device of claim 11, wherein the lookup table is derived by the processor from an inverse function of a model that defines a one-to-one correspondence between the undistorted normal coordinates and the distorted normal coordinates from an undistorted to a distorted direction.

15. The mobility device of claim 14, wherein the model defines the one-to-one correspondence using a first distortion coefficient set, which is based on distortion caused by a distance from a component acquiring image data, an undistorted radial distance of an undistorted coordinate system and a distorted radial distance of a target distorted coordinate system.

16. The mobility device of claim 15, wherein the distorted radial distance of the model is derived by the processor using a first logic that defines a relationship based on a radial angle of the distorted normal coordinates and the first distortion coefficient.

17. The mobility device of claim 16, wherein the undistorted radial distance of the inverse function is derived by the processor using a second logic that defines a relationship where the radial angle is dependent on the distorted radial distance and a second distortion coefficient.

18. The mobility device of claim 17, wherein the second logic is derived by the processor from a predefined mapping relationship between the distorted normal coordinates and the undistorted normal coordinates.

19. The mobility device of claim 17, wherein the second logic is a polynomial wherein the second distortion coefficient is determined by the processor using a polynomial curve fitting with the distorted radial distance as a dependent variable and the distorted radial distance as another dependent variable.

20. The mobility device of claim 11, wherein the processor is configured to:
calculate undistorted coordinates by mapping the depth coordinates onto the undistorted normal coordinates using the lookup table; and
transform the undistorted coordinates using a projection matrix and adjust a resolution of the bird's-eye view plane projected to meet required voxel specifications.
